(19) United States
(12) Patent Application Publication
(10) Pub. No.: US 2017/0358943 A1
(43) Pub. Date: Dec. 14, 2017

(54) ENERGY HARVESTING

(71) Applicant: KABUSHIKI KAISHA TOSHIBA, Tokyo (JP)

(72) Inventors: Mohammud Zubeir BOCUS, Bristol (GB); Aissa IKHLEF, Bristol (GB)

(73) Assignee: KABUSHIKI KAISHA TOSHIBA, Tokyo (JP)

(21) Appl. No.: 15/509,372

(22) PCT Filed: Mar. 2, 2015
(86) PCT No.: PCT/GB2015/050604

§ 371 Date: Mar. 7, 2017

(51) Int. Cl. H02J 7/02; H02J 7/00; H02J 50/20

(52) U.S. Cl. CPC H02J 7/025; H02J 50/20; H02J 7/0068

(57) ABSTRACT

A method for harvesting energy comprises determining that a guard interval portion of an RF signal will be or is occurring and consequently harvesting energy therefrom.

### FIELD

This disclosure relates to energy harvesting. In particular, but without limitation, this disclosure relates to the harvesting of energy from a guard interval portion of an RF signal.

### BACKGROUND

Recently, industrial and academic interest has been focussed on the enhancement of energy efficiency and reduction of carbon emission of communications systems. Such goals can be accomplished by either reducing the energy consumption or harvesting energy from ambient sources such as wind power, solar power, vibrations and/or electromagnetic energy. Electromagnetic energy may be harvested from Radio Frequency (RF) signals—such as those used for wireless communications—which can be used both for transmitting information and for transmitting power from one point to another.

### SUMMARY

Aspects and features of the invention are set out in the claims.

### BRIEF DESCRIPTION OF THE DRAWINGS

Examples of the present disclosure will now be described with reference to the accompanying drawings in which:

FIG. 1 shows a wireless receiving module configured to perform the methods described herein;

FIG. 2 shows a wireless device incorporating the wireless receiving module of FIG. 1;

FIG. 3 shows an illustration of an RF signal;

FIG. 4 shows a flowchart of the steps of a method described herein;

FIG. 5 shows a flowchart of the steps of a method described herein; and

FIG. 6 plots the approximate amount of power that can be harvested in an OFDM (Orthogonal Frequency-Division Multiplexing) system for different values of the SNR and lengths of cyclic prefix.

### DETAILED DESCRIPTION

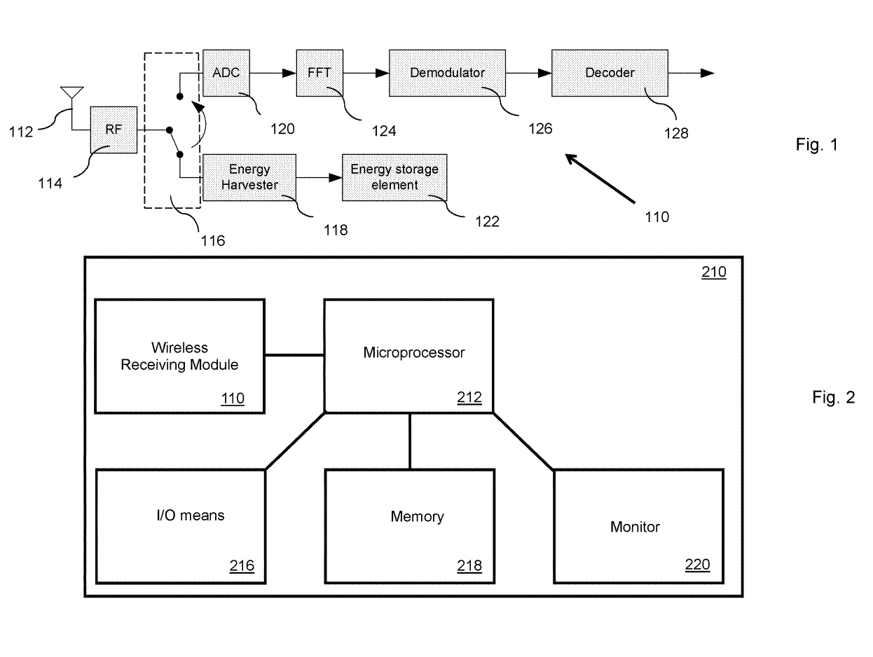

FIG. 1 shows a receiving module 110 comprising an antenna 112 coupled to Radio Frequency (RF) receiving circuitry 114 which is arranged to receive RF signals via the antenna 112. The output of the RF receiving circuitry 114 is coupled to a switch 116 which is controllable by a microprocessor (not shown). The switch 116 is operable to move between a first position wherein the output of the RF circuitry 114 is coupled to an energy harvester 118 and a second position wherein the output of the RF circuitry 114 is coupled to an Analogue to Digital Converter (ADC) 120. A person skilled in the art will understand that, whilst FIG. 1 depicts switch 116 as a simple mechanical switch, switch 116 could instead be embodied by an electronic switch, for example a relay, transistor or other semi-conductor switch. The output of the energy harvester 118 is coupled to an energy storage element 122 that is arranged to store energy extracted by the energy harvester. Examples of the energy storage element 122 include batteries and capacitors which may be arranged to directly or indirectly power a wireless device. The analogue to digital converter 120 is coupled to a Fast Fourier Transform (FFT) module 124 which is itself coupled to a demodulating module 126 which is coupled to a decoder module 128, the output of which is then conveyed to a microprocessor (not shown) for conventional processing.

FIG. 2 shows an exemplary block diagram of the macro components of a wireless device 210—for example a hub or peripheral node. The wireless device 210 comprises a microprocessor 212 arranged to execute computer readable instructions as may be provided to the wireless device 210 via one or more of: a wireless receiving module 110 being arranged to enable the microprocessor 212 to communicate wirelessly with a network; a plurality of input/output interfaces 216 which may include one or more buttons, touch screen, a keyboard and a board connection (for example a USB connection); and a memory 218 that is arranged to be able to retrieve and provide to the microprocessor 212 instructions and data that has been stored in the memory 218. The microprocessor 212 may further be coupled to a monitor upon which a user interface may be displayed and further upon which the results of processing and/or sensing operations may be presented. In this case, the input/output interfaces 216 are arranged to control the switch 116 and to receive decoded signal from the decoder module 128.

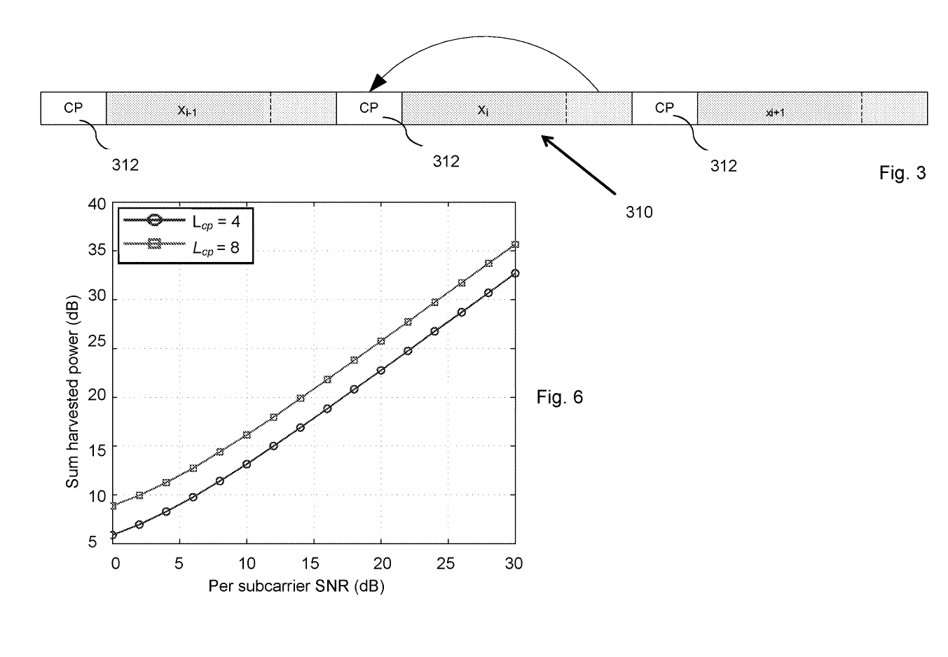

The inventors have arrived at an insight that there is scope to harvest energy from several parts of an RF signal without affecting the signal. In particular, when packetized signals are transmitted over wideband/frequency selective channels, a guard interval is appended at the beginning of the transmit signal to combat inter-symbol interference. Guard intervals in RF signals can occupy up to 25% of a symbol duration and often contain cyclic prefixes (CPs), but may come in other forms such as unique words or zero padding. FIG. 3 shows an illustration of an exemplary RF signal 310 containing guard interval portions 312—in this case cyclic prefixes. In the cyclic prefix approach, the last L symbols of a message packet, where L is greater than the number of channel taps, is appended to the beginning of the packet. At the receiving end, the guard interval is discarded before any signal processing is performed on the remainder of the message. Accordingly, energy may be harvested from the guard interval, or portions thereof, without degrading the message content of the RF signal.

Consider a communication system operating over a frequency selective channel. Let the channel be represented by L taps. The digital transmit signal can be represented by

y=T*\tilde{x}

where \tilde{x} is the message vector of length N after appropriate processing and T∈C^{(P+L)×N} is the matrix of responsible for the addition of a guard interval of length P>L at the beginning of the of transmitted message. For OFDM systems,

\tilde{x}=F^{H}x

where F is the fast Fourier transform (FFT) matrix and x is the vector of message symbols.

The signal at the receiver, prior to removing the guard interval can be expressed as

r=Hy+n

where H is the Toeplitz channel matrix with first column [h₀, h₁, . . . , h_{L-1}, 0, . . . , 0]^{T} and n is the additive white Gaussian noise vector. As previously mentioned, in conventional systems, the guard interval is usually discarded. Although the insertion of the guard interval is beneficial for combating ISI (Inter Symbol Interference), the presence of the guard interval reduces the energy efficiency of the system. The approaches described herein recover energy from the guard interval which would otherwise be discarded and convert it into electrical energy for storage or use by other components.

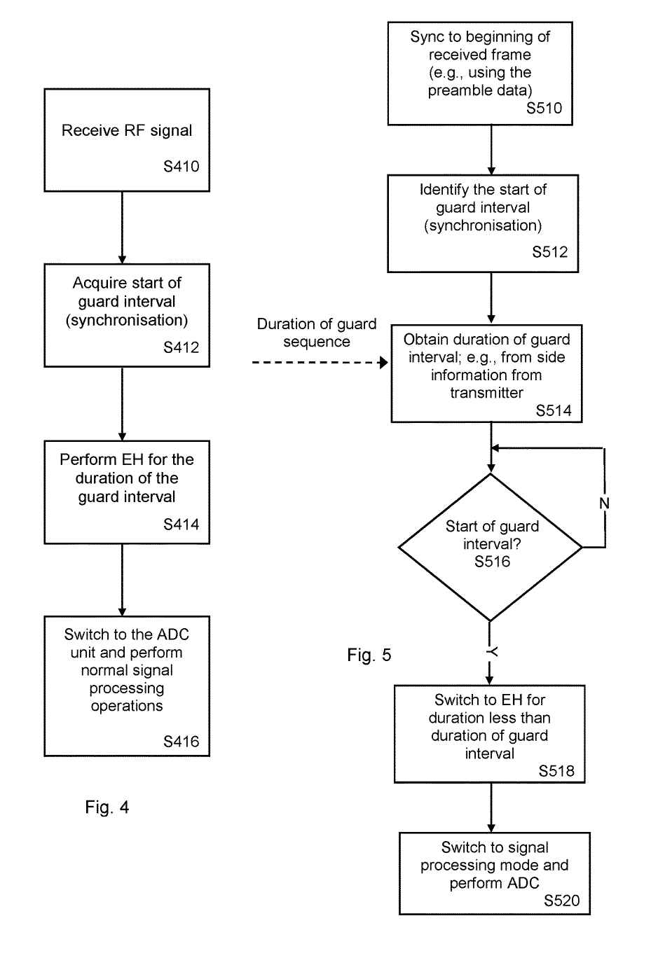

FIG. 4 shows a flowchart of the steps of a method for harvesting energy from a guard interval. At step S410, an RF signal containing a guard interval is received, for example by the antenna 112. At step S412, a determination as to when the start of the guard interval will occur is made. As one possibility, the determination is made by the microprocessor 212 based upon information that is contained within the RF signal and which has been received by the antenna and decoded by the decoder module 128. For example, the structure of the RF signal may enable the microprocessor to determine when the guard interval is expected to start occurring or whether the guard interval is occurring. Likewise, the structure of the RF signal may enable the microprocessor to determine the duration of the guard interval and/or when the end of the guard interval will occur. As another or additional possibility, the microprocessor 212 may receive explicit information about: when the guard interval will start, whether the guard interval is occurring, the duration of the guard interval and/or when the guard interval will end. That information may be received by the microprocessor 212 in an RF signal received at the antenna 112 and subsequently decoded by the decoder module 128 and the RF signal containing the information may be the same as, or different to, the RF signal from which energy is harvested. A person skilled in the art would recognise other manners by which the microprocessor 212 could receive that information.

At step S414, energy is harvested from the RF signal received by the antenna 112 during the guard interval. In the example of FIG. 4, the energy is harvested for the entire duration of the guard interval. However, the energy may also be harvested for only a portion of the guard interval portion of the RF signal. For example, for OFDM signals, the FFT timing window may start within the CP to eliminate ISI and so only a portion of the CP would be used for energy harvesting. If the delay spread of the channel is k, energy can be harvested from a portion equal P−k without affecting ISI.

One manner of harvesting the energy at step S414 is for the microprocessor 212 to control switch 116 so that the RF signal is conveyed from the RF receiving circuitry 114 to the energy harvester 118. As one possibility, whilst the RF signal is being conveyed to the energy harvesting unit, operation of the ADC 120 is stopped so as to avoid unnecessary power consumption.

At step S416, a determination is made (using the approaches described herein) that the guard interval is about to end and energy harvesting is stopped at or before the end of the guard interval.

One manner of stopping the energy harvesting at step S416 is for the microprocessor 212 to control switch 116 so that the RF signal is conveyed from the RF receiving circuitry 114 to the ADC 120 so that normal signal processing operations can be performed on the received signal.

As illustrated in FIG. 4, to harvest energy from the guard interval, a switching operation is performed before the ADC operation. In OFDM examples, this effectively requires the receiver to be synchronised to the OFDM frame.

Once a coarse synchronisation is obtained, for instance using the long preambles in the WIFI frames, it is possible to know where the start of the guard interval would be within the received sequence. Based on this knowledge and the length of the cyclic prefix, which can, for example, be explicitly sent to the receiver or contained within the preamble data, the end of the guard internal can also be determined. A flowchart illustrating the switching operation is shown in FIG. 5.

At step S510, an initial synchronisation is performed using the beginning of a frame received at the antenna 112. At step S512, the start of the guard interval is identified and at step S514, the duration of the guard interval is determined for example from signalling information sent by the transmitter and/or the preamble of a signal received by the antenna 112. At step S516, the start of the guard interval is waited for and at step S518, once the guard interval has started, the switch 116 is operated so as to convey the received RF signal to the energy harvester 118 for a duration less than or equal to the duration of the guard interval. Once that duration has passed, at step S520, the switch 116 is operated so as to convey the received RF signal to the ADC 120 for analogue to digital conversion. As one possibility, instead of conveying the received RF signal to the ADC 120, the received RF signal could be conveyed to a general signal processing unit for signal processing. A skilled person would recognise that such a signal processing unit may comprise any or all of the ADC 120, the FFT module 124, the demodulator module 126, and the decoder module 128.

To illustrate the potential of the approaches descried herein, the received signal in digital representation is considered below. By the law of conservation of energy, this representation provides a good approximation of the energy harvestable in the analogue domain. Accordingly, the below is an approximation of the amount of energy that can be harvested in practice since the harvesting operation is performed prior to the analogue to digital conversion.

The portion of the signal harvested may be represented as

r_{E}=R_{EH}r

where R_{EH} is the matrix responsible for harvesting from the CP. From a practical perspective, it is realised that the whole CP may not be used for EH since the FFT timing window normally starts within the CP to eliminate inter-symbol interference. Instead, as one possibility, only part of the CP would be used.

The expected amount of harvested energy can be expressed as

E_{H}=αE[|r_{E}|²]=α(E|R_{EH}HT\tilde{x}|²+σₙ²)>0

with σₙ² representing the noise variance and 0<α≦1 represents the efficiency of the RF energy harvesting unit.

The amount of energy from the cyclic prefix in an OFDM system is illustrated in FIG. 6, where it is assumed that σₙ²=1 and α=0.5 . A total of N=32 subcarriers are considered with different cyclic prefix lengths, L_{cp}. Whereas, for conventional, non-energy harvesting systems, no power is harvested, in the approaches described herein, some or all of the energy of the cyclic prefix may be harvested.

Preferably, the energy harvesting operation is carried out prior to the ADC operation, i.e., the harvesting process in performed on the analogue signal. In such cases, a switching operation is performed as described above. As the signal is received, an EH unit is operated for the duration corresponding to the guard interval, after which the receiver switches back to the ADC unit. After the ADC unit in this case, there is no need for guard removal—instead, the FFT operation (for OFDM) is directly applied after the ADC. As ADCs are very power hungry, performing the energy harvesting prior to the ADC receiving the RF signal avoids the need to operate the ADC during energy harvesting thereby reducing energy consumption.

Although the approaches described herein have been presented in the context of OFDM, those approaches are applicable to any system with guard interval, such as SC-FDE or SC-FDMA among others. Further, the approaches described herein may be employed in conjunction with other forms of RF energy harvesting.

Examples of the described approaches are set out in the below list of numbered clauses:
1. An apparatus or procedure at the receiving end of a communications system where portions of the received signal which are usually discarded are used for energy harvesting purposes. For example, in an OFDM system, the method would harvest energy from the cyclic prefix or guard interval.
2. A method where the receiving node can switch between energy harvesting mode and signal processing mode based on the timing of the guard interval.
3. A method for determining the start and duration of the guard interval in the received sequence. Based on this knowledge, the receiving device can switch between the energy harvesting phase and signal processing mode.
4. A method whereby the transmitting node sends information regarding the duration of the guard interval to the receiver.
5. The receiving device determines the start of the guard interval based on the signal structure, such as the preambles and presence of training sequences.
6. A method for extending the lifetime of a battery operated receiving node by harvesting energy from those portions of the received signal that would typically be discarded.
7. A means of harvesting from only a portion of the guard interval at the receiving device such that inter-symbol interference does not affect the signal.

As one possibility, whilst the RF signal is being conveyed to the energy harvesting unit, the operation of the ADC is stopped—for example by removing its power source.

Energy harvesters as mentioned herein are generally passive devices that do not draw power for operation. The harvested energy can be stored using conventional storage devices such as batteries or capacitors or used directly to power other low power circuitry. A person skilled in the art will understand that the approaches described herein need not be limited to use with any specific type of energy harvester and that instead they may be used with any available energy harvester.

There is described herein a method for harvesting energy that comprises determining that a guard interval portion of an RF signal will be or is occurring and consequently harvesting energy therefrom.

The approaches described herein may be embodied in any appropriate form including hardware, firmware, and/or software, for example on a computer readable medium, which may be a non-transitory computer readable medium. The computer readable medium carrying computer readable instructions arranged for execution upon a processor so as to make the processor carry out any or all of the methods described herein.

The term computer readable medium as used herein refers to any medium that stores data and/or instructions for causing a processor to operate in a specific manner. Such a storage medium may comprise non-volatile media and/or volatile media. Non-volatile media may include, for example, optical or magnetic disks. Volatile media may include dynamic memory. Exemplary forms of storage medium include, a floppy disk, a flexible disk, a hard disk, a solid state drive, a magnetic tape, any other magnetic data storage medium, a CD-ROM, any other optical data storage medium, any physical medium with one or more patterns of holes or protrusions, a RAM, a PROM, an EPROM, a FLASH-EPROM, NVRAM, and any other memory chip or cartridge.

1. A method for harvesting energy from a guard interval portion of an RF signal, the method comprising the steps of:
(a) determining at least one of:
when the guard interval portion of the RF signal will occur, and
that the guard interval portion of the RF signal is occurring; and
(b) consequent to step (a), conveying, whilst the guard interval portion of the RF signal is occurring, the RF signal to an energy harvesting unit arranged to harvest energy from the RF signal for storage.

2. The method of claim 1, further comprising the steps of:
(c) determining when the guard interval portion of the RF signal will not occur; and
(d) consequent to step (c), conveying the RF signal to a signal processing unit whilst the guard interval is not occurring.

3. The method of claim 2, further comprising, subsequent to step (b), but prior to step (d), conveying the RF signal to a signal processing unit whilst the guard interval is occurring.

4. The method of claim 2, wherein step (c) comprises determining when the end of the guard interval portion of the RF signal will occur.

5. The method of claim 4, wherein the determining when the end of the guard interval portion of the RF signal will occur comprises at least one of:
receiving information about when the end of the guard interval portion of the RF signal will occur; and
determining when end of the guard interval portion of the RF signal will occur based on the structure of the RF signal.

6. The method of claim 2, wherein step (c) comprises determining the duration of the guard interval portion of the RF signal.

7. The method of claim 6, wherein the determining the duration of the guard interval portion of the RF signal comprises at least one of:
receiving information about the duration of the guard interval portion of the RF signal; and
determining the duration of the guard interval portion of the RF signal based on the structure of the RF signal.

8. The method of claim 1, wherein step (a) comprises the step of determining when the start of the guard interval portion of the RF signal will occur.

9. The method of claim 8 wherein the step of determining when the start of the guard interval portion of the RF signal will occur comprises at least one of:
receiving information about when the start of the guard interval portion of the RF signal will occur; and
determining when start of the guard interval portion of the RF signal will occur based on the structure of the RF signal.

10. The method of claim 8, wherein step (b) occurs after the start of the guard interval portion of the RF signal.

11. The method of claim 1, wherein the energy harvesting unit comprises a battery and/or capacitor for storing energy harvested from the RF signal.

12. The method of claim 1, wherein the guard interval portion of the RF signal comprises a cyclic prefix.

13. The method of claim 1, wherein the guard interval portion of the RF signal that is conveyed to the energy harvesting unit at step (b) is conveyed without having been processed by an Analogue to Digital Converter, ADC, arranged to process the received RF signal.

14. An apparatus arranged to perform a method, the method comprising the steps of:
(a) determining at least one of:
when the guard interval portion of the RF signal will occur, and
that the guard interval portion of the RF signal is occurring; and
(b) consequent to step (a), conveying, whilst the guard interval portion of the RF signal is occurring, the RF signal to an energy harvesting unit arranged to harvest energy from the RF signal for storage.

15. A non-transitory computer readable medium comprising machine readable instructions arranged, when executed by one or more processors, to cause the one or more processors to carry out a method, the method comprising the steps of:
(a) determining at least one of:
when the guard interval portion of the RF signal will occur, and
that the guard interval portion of the RF signal is occurring; and
(b) consquent to step (a), conveying, whilst the guard interval portion of the RF signal is occurring, the RF signal to an energy harvesting unit arranged to harvest energy from the RF signal for storage.
